(19) United States
(12) Patent Application Publication
(10) Pub. No.: US 2016/0338393 A1
(43) Pub. Date: Nov. 24, 2016

(54) Snack Food Pellets

(71) Applicant: FRITO-LAY TRADING COMPANY GMBH, Berne (CH)

(72) Inventors: Rachael ALLEN, Coventry (GB); Bruce R. LINTER, Leicester (GB)

(73) Assignee: Frito-Lay Trading Company GmbH, Beme (CH)

(21) Appl. No.: 15/115,050

(22) PCT Filed: Feb. 5, 2015
(86) PCT No.: PCT/EP2015/052395

§ 371 Date: Jul. 28, 2016

(30) Foreign Application Priority Data
Feb. 5, 2014 (GB) 1401966.5

(51) Int. Cl. A23L 5/20; A23L 19/12; A23L 29/212; A23L 7/117

(52) U.S. Cl. CPC A23L 5/20; A23L 7/117; A23L 19/12; A23L 29/212; A23V 2002/00

(57) ABSTRACT

A starch-based snack food pellet for manufacturing an expanded snack food, the pellet being essentially free of sodium chloride and comprising a starch matrix, the starch matrix including a crystalline fraction and an amorphous fraction, wherein the weight ratio of the crystalline fraction to the amorphous fraction is from 0.52 to 0.60.

### CROSS-REFERENCE TO RELATED APPLICATIONS

This application is a U.S. 371 National Stage Application from PCT/EP2015/052395 filed Feb. 5, 2015, which claims priority to United Kingdom Application No. GB1401966.5 filed Feb. 5, 2014, the technical disclosures of which are hereby incorporated herein by reference.

### TECHNICAL FIELD

The present invention relates to a starch-based snack food pellet for manufacturing an expanded snack food, an expanded snack food, and a method of reducing the sodium chloride content of an expanded snack food produced from a starch-based snack food pellet.

### DESCRIPTION OF RELATED ART

The use of starch-based pellets to produce snack foods, typically in the form of snack chips, is well known in the art. The pellet is produced by extrusion. On subsequent cooking, the pellet expands to produce an expanded low density porous snack food.

The pellets include a high proportion of starch. It is essential that, when subjected to rapid high temperature cooking, the starch expands to produce a light and highly porous structure in the expanded snack food which is substantially homogeneous and substantially avoids the presence of unexpanded glassy regions.

Known snack food pellets include a dose, typically a high dose, of sodium chloride which is provided to ensure that the light and highly porous structure in the expanded snack is reliably achieved. The sodium chloride content of some known pellet compositions is from 0.8-5 wt % salt based on the weight of the pellet. In the absence of sodium chloride, the pellet tends to suffer from low or minimal expansion, and may exhibit an unexpanded glassy phase.

### SUMMARY OF THE INVENTION

There is a general desire to reduce the salt content of many foods, including processed foods such as snack chips. However, for expanded snack foods produced from pellets, there is a problem of achieving a reduced sodium chloride content of the pellet, and in the resultant expanded snack food product, while also achieving the desired uniform light and airy expanded structure required by consumers.

The present invention aims to solve this problem of the production of known expanded snack foods produced from pellets.

Accordingly, the present invention provides a starch-based snack food pellet for manufacturing an expanded snack food, the pellet being essentially free of sodium chloride and comprising a starch matrix, the starch matrix including a crystalline fraction and an amorphous fraction, wherein the weight ratio of the crystalline fraction to the amorphous fraction is from 0.52 to 0.60.

The present invention further provides a starch-based snack food pellet for manufacturing an expanded snack food, the pellet comprising from greater than 1 to up to 8 wt % sodium chloride, based on the total weight of the pellet, and comprising a starch matrix, the starch matrix including a crystalline fraction and an amorphous fraction, wherein the weight ratio of the crystalline fraction to the amorphous fraction is from 0.52 to 0.60.

The present invention still further provides a starch-based snack food pellet for manufacturing an expanded snack food, the pellet comprising a starch matrix, the starch matrix including a crystalline fraction and an amorphous fraction, the pellet having an initial water content of from 8 to 14 wt % based on the weight of the pellet, wherein the pellet starch matrix has a water absorption of from 15 to 25 wt %, based on the weight of the starch matrix when the starch matrix is disposed in an atmosphere having a relative humidity of 90 wt % water vapour at a temperature of 24.9° C.

The present invention yet further provides a starch-based snack food pellet for manufacturing an expanded snack food, the pellet comprising a blend of a first starch component in which a majority of the starch is present in a crystalline form and a second starch component in which a majority of the starch is present in an amorphous form, the weight of the first starch component in the blend being greater than the weight of the second starch component in the blend, wherein a first temperature peak, as measured by differential scanning calorimetry, associated with amylopectin in the blend of the first and second starch components is at substantially the same temperature as a second temperature peak, as measured by differential scanning calorimetry, associated with amylopectin of a reference composition, the reference composition comprising the first starch component in combination with 0.89 wt % sodium chloride based on the weight of the reference composition.

The present invention further provides an expanded snack food produced from the starch-based snack food pellet according to the present invention. The expanded snack food may optionally be fried, baked, microwaved, directly extruded or popped.

The present invention further provides a method of reducing the sodium chloride content of an expanded snack food produced from a starch-based snack food pellet, the method comprising the steps of:
providing an initial composition for forming a starch-based snack food pellet, the composition comprising a starch matrix and sodium chloride, the starch matrix including a crystalline fraction and an amorphous fraction;
reducing the sodium chloride content of the composition; and
reducing the weight ratio between the crystalline fraction and the amorphous fraction to form a reduced sodium chloride composition.

Preferred features of all of these aspects of the present invention are defined in the dependent claims.

### BRIEF DESCRIPTION OF THE DRAWINGS

Embodiments of the present invention will now be described by way of example only, with reference to the accompanying drawings, in which:

FIG. 1 is a photomicrograph obtained by X-ray tomography of a cross-section through an expanded snack food piece produced from a known starch-based pellet comprising sodium chloride;

FIG. 2 is a photomicrograph obtained by X-ray tomography of a cross-section through an expanded snack food piece produced from a pellet having the same starch-based composition as for the pellet of FIG. 1 but not comprising sodium chloride;

FIG. 3 is a graph showing the relationship between the change in mass by water absorption and relative humidity for two starch-based compositions when exposed to a humid atmospheric environment at an ambient temperature at increasing relative humidity;

FIG. 4 is a graph showing the relationship between the change in mass by water desorption and relative humidity for two starch-based compositions when exposed to a humid atmospheric environment at an ambient temperature at decreasing relative humidity;

FIG. 5 is a graph showing the relationship between the heat capacity and temperature, as determined by differential scanning calorimetry (DSC), for two starch-based compositions, one of which comprises sodium chloride and the other of which does not comprise sodium chloride;

FIG. 6 is a graph showing the relationship between the ratio of the amount (wt %) of crystalline starch to the amount (wt %) of amorphous starch for varying amounts of sodium chloride in a starch-based composition;

FIG. 7 is a photomicrograph obtained by X-ray tomography of a cross-section through an expanded snack food piece produced in accordance with an embodiment of the present invention from a pellet having a modified starch-based composition which does not comprise sodium chloride; and

FIG. 8 is a graph showing the relationship between the matrix hydrogen mobility and temperature for three starch-based compositions, one such composition being in accordance with an embodiment of the present invention and two such compositions not being in accordance with the present invention.

### DETAILED DESCRIPTION OF THE INVENTION

The present invention is at least partly predicated on the finding by the present inventors that when sodium chloride is present in a starch-based snack food pellet, the sodium chloride has a particular structural effect on the starch component both during processing and when the pellet is subjected to expansion to form a snack food piece. Such a structural effect can be compensated for in a starch-based pellet composition with a reduced sodium chloride content, or even a starch-based pellet composition with zero sodium chloride content, by providing a specific crystallinity/amorphous profile for the starch component(s).

Without being bound by any theory, it is believed that in known starch-based pellet compositions, the starch is primarily crystalline in structure. This crystalline structure, with a high degree of molecular order between the starch molecules, promotes a high degree of hydrogen bonding between the starch molecules. Such hydrogen bonding is broken down or disrupted by the addition of sodium chloride to the starch-based composition.

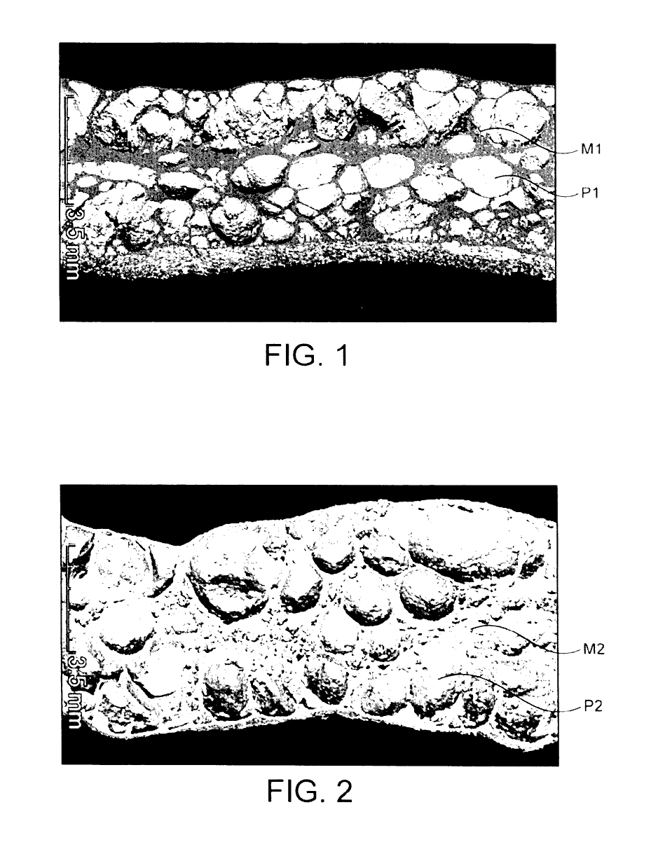

This disruption in turn provides that the starch-based matrix has a higher mobility during the expansion phase when forming the expanded snack food piece from the pellet and is more hydrophilic in nature. The disrupted regions of the starch can then readily be expanded during the cooking process to produce a substantially uniformly expanded microstructure, as shown in FIG. 1. In particular, it is believed that an increased sodium chloride concentration tends to increase the mobility of water within the starch so that the water molecules are more homogeneously distributed throughout the starch structure.

FIG. 1 is a cross-section, obtained by X-ray tomography, through an expanded snack food chip which has been produced by frying in hot oil a pellet comprising a starch-based composition including 0.89 wt % sodium chloride. The expanded snack food chip comprises a matrix phase M1 and a plurality of hollow pores P1 distributed within the matrix phase Ml. The hollow pores P1 provide the light and airy expanded structure required by consumers. The hollow pores P1 have a substantially homogeneous size and distribution throughout the matrix phase Ml. This provides that the expanded snack food chip has the desired expanded structure uniformly present in the chip. There is substantially no unexpanded glassy phase.

In contrast, FIG. 2 is a cross-section, obtained by X-ray tomography, through an expanded snack food chip which has been produced by frying in hot oil a pellet comprising the same starch-based composition as used for the chip of FIG. 1 but the composition does not include any sodium chloride. The expanded snack food chip again comprises a matrix phase M2 and a plurality of hollow pores P2 distributed within the matrix phase M2. However, the hollow pores P2 do not provide the light and airy expanded structure required by consumers. The hollow pores P2 have a substantially heterogeneous size and distribution throughout the matrix phase M2. As compared to FIG. 1, there are fewer pores P2 which are larger in dimension and this results in larger volume regions of unexpanded or insufficiently expanded matrix phase P2 between the pores P2. This provides that the expanded snack food chip does not have the desired expanded structure uniformly present in the chip; instead there are glassy unexpanded regions.

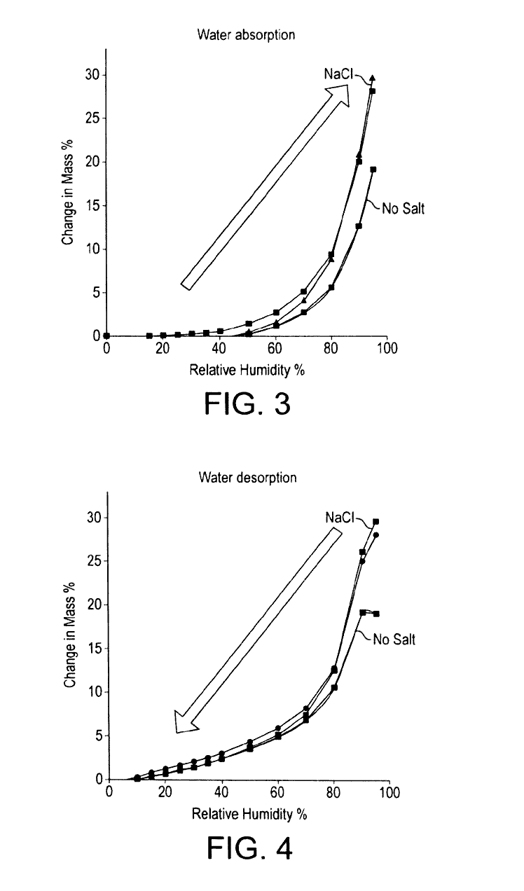

FIG. 3 is a graph showing the relationship between the change in mass by water absorption and relative humidity for two starch-based compositions when exposed to a humid atmospheric environment at an ambient temperature at increasing relative humidity. As shown in FIG. 3, when a starch-based composition is exposed to a humid atmospheric environment at an ambient temperature (in the particular test the temperature was 24.9° C.), when the composition comprises sodium chloride the water absorption by the starch is greater, within the same time period, than if the composition does not comprise sodium chloride.

Correspondingly, FIG. 4 is a graph showing the relationship between the change in mass by water desorption and relative humidity for two starch-based compositions when exposed to a humid atmospheric environment at an ambient temperature at decreasing relative humidity. As shown in FIG. 4, when a starch-based composition is exposed to a humid atmospheric environment at an ambient temperature (in the particular test the temperature was 24.9° C.), when the composition comprises sodium chloride the water desorption by the starch is greater, within the same time period, than if the composition does not comprise sodium chloride.

FIGS. 3 and 4 show that the addition of sodium chloride to starch tends to both increase the absorption of water into, and increase the desorption of water from, the starch as compared to when the starch is free of sodium chloride.

When the pellet is cooked, during the expansion phase, the water evaporates to form steam, which in turn forms the pores. It is believed that an increased water mobility within the starch coupled with increased starch mobility and hydrophilicity provides a higher number of stable pore nucleation sites throughout the starch-based pellet composition, resulting in a large number of homogeneously distributed pores, as shown in FIG. 1.

In contrast, in the absence of sodium chloride in a starch-based pellet composition in which the starch is primarily crystalline in structure, it is believed that the high degree of hydrogen bonding between the starch molecules tends to provide that the starch-based matrix has a low mobility during the expansion phase and low mobility of water within the starch. The crystalline regions of the starch cannot readily be expanded during the cooking process, and accordingly a non-uniformly expanded microstructure is produced, as shown in FIG. 2.

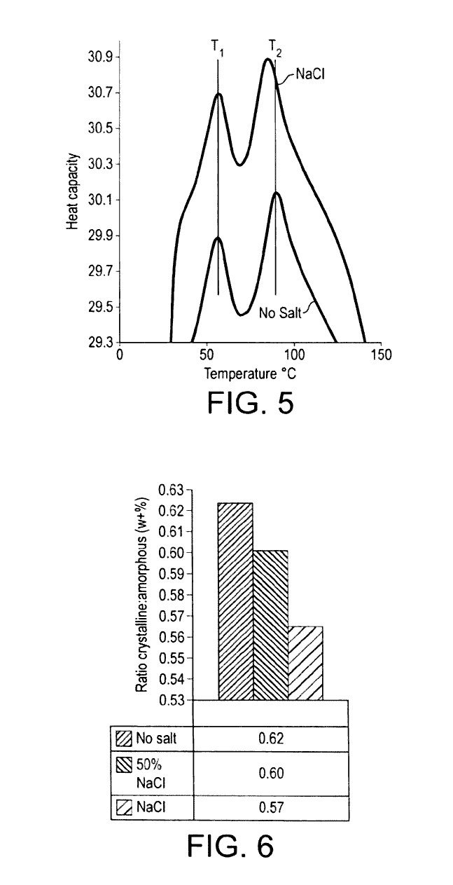

FIG. 5 is a graph showing the relationship between the heat capacity and temperature, as determined by differential scanning calorimetry (DSC) for two starch-based compositions, one of which comprises sodium chloride and the other of which does not comprise sodium chloride. Each DSC plot has two peaks, the lower temperature peak T₁ corresponding to amylose in the starch and the higher temperature peak T₂ corresponding to amylopectin in the starch.

The temperature of the amylose peak T₁ is the same for the two compositions. It is believed that this static behaviour is because the amylose in the starch is lipophilic and composed of lipid complexed molecular portions which are substantially unaffected by the addition of sodium chloride to the starch.

In contrast, when sodium chloride is added to the starch, the temperature of the amylopectin peak T₂ is lowered. It is believed that this lowered temperature behaviour is because the amylopectin is hydrophilic and complexes with water by hydrogen bonding. Sodium chloride disrupts the intramolecular hydrogen bonding within the starch molecules, allowing water in to the disrupted structure, which is more mobile, and consequently the transition temperature of the glassy matrix represented by the amylopectin peak is reduced.

In the embodiment tested the temperature of the amylose peak T₁ was about 56° C., and the temperature of the amylopectin peak T₂ was lowered from about 90° C. to about 86° C.

FIG. 6 is a graph showing the relationship between the ratio of the amount (wt %) of crystalline starch to the amount (wt %) of amorphous starch for varying amounts of sodium chloride in a starch-based composition. These ratios were determined by Fourier Transform Infrared spectroscopy (FTIR), a technique known in the art. Three starch-based compositions were tested, a first composition containing 0.89 wt % sodium chloride, a second composition containing 0.45 wt % sodium chloride and a third composition not containing any sodium chloride.

It may be seen that the addition of sodium chloride to the starch-based composition reduces the ratio of the amount of crystalline starch to the amount of amorphous starch. It is believed that this effect is achieved by the sodium chloride reducing the amount of crystalline starch as a result of disrupting the hydrogen bonding between starch molecules as discussed hereinabove.

In devising the present invention, the inventors have found that by providing a specific crystallinity/amorphous profile for the starch component(s), in particular an increased amorphous starch content, and a reduced crystalline starch content, there is a reduced degree of hydrogen bonding between the starch molecules because such hydrogen bonding tends not to be present in the amorphous structure which has a low degree of molecular order between the starch molecules.

Consequently, the higher concentration of amorphous starch can provide a starch mobility and water mobility in the amorphous regions which has a similar effect to the starch disruption provided by the addition of sodium chloride to the highly crystalline starch-based composition. This increased amorphous starch content provides that the starch-based matrix has a higher mobility during the expansion phase, and the disrupted regions of the starch can then readily be expanded during the cooking process to produce a substantially uniformly expanded microstructure, similar to that shown in FIG. 1, but with reduced or even zero sodium chloride concentration in the starch-based composition.

The amorphous regions are correspondingly believed to increase the mobility of water within the starch so that the water can be more homogeneously distributed throughout the starch structure. During the expansion phase, the water evaporates to form steam, which in turn forms the pores. It is believed that an increased water mobility within the starch coupled with increased starch mobility provides a higher number of stable pore nucleation sites throughout the starch-based pellet composition, resulting in a large number of homogeneously distributed pores.

In short, in accordance with the preferred embodiments of the present invention the starch composition for the pellet is manipulated to provide a ratio of crystalline starch to amorphous starch which compensates for the effect of adding sodium chloride to a starch which produces a highly crystalline pellet.

This manipulation of the starch-based composition may be achieved by adding a relatively amorphous starch component to a relatively crystalline starch, the amorphous starch component being more amorphous than the crystalline starch and the crystalline starch being more crystalline than the amorphous starch component. However, other starch blends or starch treatments may be employed to provide a starch-based composition having the desired relationship between the amorphous starch and the crystalline starch to enable the starch-based composition, having a reduced or zero sodium chloride concentration, to be formulated as a pellet which exhibits the desired uniform expansion characteristics when the pellet is cooked.

In accordance with one aspect of the present invention there is provided a starch-based snack food pellet for manufacturing an expanded snack food. The pellet comprises a starch matrix. Typically, the pellet comprises from 70 to 99 wt % starch, optionally from 80 to 99 wt % starch, based on the total weight of the pellet. The starch matrix may include potato starch. However, other starch sources may alternatively or additionally be employed.

The pellet starch matrix includes a crystalline fraction and an amorphous fraction. In one embodiment, the weight ratio of the crystalline fraction to the amorphous fraction is from 0.52 to 0.60, optionally from 0.54 to 0.58. The pellet starch matrix may include from 50 to 95 wt % crystalline fraction and from 5 to 50 wt % amorphous fraction.

The starch matrix comprises a first relatively crystalline starch composition and a second relatively amorphous starch composition, the amorphous starch component being more amorphous than the crystalline starch and the crystalline starch being more crystalline than the amorphous starch component, which preferably have been blended together to form the starch matrix. The first starch composition may be at least 25 wt % crystalline based on the weight of the first starch composition and/or the second starch composition may be at least 80 wt % amorphous based on the weight of the second starch composition. The first starch composition may comprise a majority of crystalline starch and a minority of amorphous starch, and optionally may be substantially crystalline, whereas the second starch composition may comprise a majority of amorphous starch and a minority of crystalline starch, and optionally may be substantially amorphous. Typically, the starch matrix includes from 75 to 95 wt %, optionally from 80 to 90 wt %, of the first starch composition and from 5 to 25 wt %, optionally from 10 to 20 wt %, of the amorphous second starch composition.

In one embodiment, the first starch composition was a conventional commercial potato starch having a higher degree of crystallinity and the second starch composition was a highly amorphous potato starch product, in particular a refined potato starch available in commerce under the trade name N-Hance 69 from Ingredion UK Limited, Manchester, United Kingdom. The starch matrix comprised 90 wt % of the higher crystalline first starch composition and 10 wt % of the highly amorphous second starch composition. The resultant starch blend provided in the resultant pellet a weight ratio of the crystalline fraction to the amorphous fraction of from 0.1-0.35.

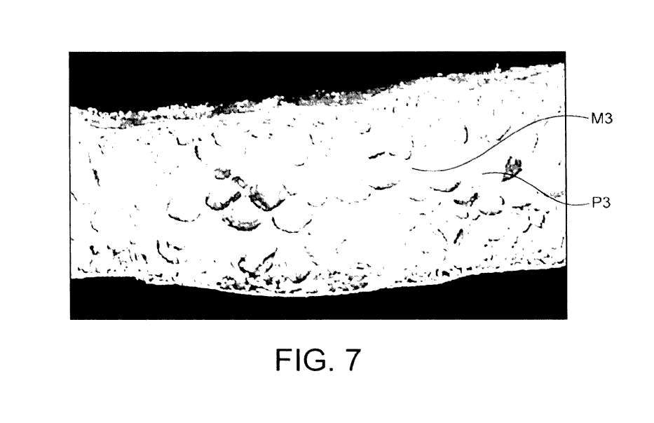

In this embodiment, the starch-based composition was free of sodium chloride and was formulated into a pellet and then fried in hot oil to produce an expanded snack food piece, similar to the production of the snack food pieces illustrated in FIGS. 1 and 2. FIG. 7 is a photomicrograph of a cross-section through the expanded snack food piece produced in accordance with this embodiment of the present invention from that pellet having a modified starch-based composition which does not comprise sodium chloride.

FIG. 7 shows that the expanded microstructure in the snack food piece produced in accordance with an embodiment of the present invention from a starch having a high amorphous starch fraction is similar to that of the sodium chloride-containing higher crystalline starch composition of FIG. 1. The pores P3 and matrix M3 are shown. FIG. 7 also shows that that the expanded microstructure in the snack food piece produced in accordance with an embodiment of the present invention from a starch having a high amorphous starch fraction has a significantly more homogeneous pore size and distribution as compared to the sodium chloride-free high crystalline starch composition of FIG. 2.

In other words, FIGS. 1, 2 and 7 cumulatively show that modifying the ratio of the amorphous and crystalline starch fractions can wholly or partly compensate, with regard to the achievement of a desired expanded microstructure, for the addition of sodium chloride to the starch-based composition forming the precursor pellet.

Modifying the ratio of the amorphous and crystalline starch fractions correspondingly can lower the temperature of the amylopectin peak of the starch matrix, as measured by differential scanning calorimetry and discussed above with reference to FIG. 5. The increased amorphous starch fraction enables the interaction of the hydrophilic amylopectin with water. This reduces the overall degree of hydrogen bonding of the starch, thereby allowing water in to the more open structure, which is more mobile, and consequently the transition temperature of the glassy matrix represented by the amylopectin peak is reduced.

Accordingly, in preferred embodiments of the present invention, the starch matrix, when subjected to differential scanning calorimetry, has a temperature difference between a relatively low temperature peak associated with amylose in the starch and a relatively high temperature peak associated with amylopectin in the starch, the temperature difference being from 10 to 32° C., optionally from 17 to 30° C. The temperature peak associated with amylopectin in the starch is typically within the range of from 71 to 103° C., optionally from 80 to 88° C.

Preferably, the pellet comprises a blend of a first starch component in which a majority of the starch is present in a crystalline form and a second starch component in which a majority of the starch is present in an amorphous form. The weight of the first starch component in the blend is greater than the weight of the second starch component in the blend. A first temperature peak, as measured by differential scanning calorimetry, associated with amylopectin in the blend of the first and second starch components is at substantially the same temperature as a second temperature peak, as measured by differential scanning calorimetry, associated with amylopectin of a reference composition, the reference composition comprising the first starch component in combination with 15 wt % sodium chloride based on the weight of the reference composition. Typically, the first temperature peak is within +/−5° C. of the second temperature, for example within +/−2° C. of the second temperature.

The pellet starch matrix, which has an initial water content of from 8 to 14 wt %, typically 11 wt %, based on the weight of the pellet, has a water absorption of from 15 to 25 wt %, typically from 18 to 22 wt %, based on the weight of the starch matrix, when the starch matrix is disposed in an atmosphere having a relative humidity of 90 wt % water vapour at a temperature of 24.9° C.

In accordance with one embodiment of the present invention, the pellet is essentially free of sodium chloride for example the pellet comprising no more than 0.2 wt % sodium chloride, optionally no more than 0.1 wt % sodium chloride, based on the total weight of the pellet.

In accordance with another embodiment of the present invention, the pellet comprises from 0.4 to 2 wt % sodium chloride, optionally from 0.5 to 1 wt % sodium chloride, based on the total weight of the pellet.

Typically, the pellet comprises no more than 15 wt % water, optionally from 8 to 14 wt % water, based on the total weight of the pellet.

The pellet typically further comprises at least one fibrous vegetable-derived ingredient and/or at least one fibrous cereal-derived ingredient. The fibrous vegetable-derived ingredient may comprise a potato ingredient, for example derived from fresh potato, dehydrated potato and/or potato powder. The fibrous cereal-derived ingredient may comprise at least one of a maize, wheat, oat, rice or barley ingredient.

In accordance with the present invention, an expanded snack food is produced from the starch-based snack food pellet. The expanded snack food may be fried, baked, microwaved, directly extruded or popped, each of these pellet expansion methods being known per se to persons skilled in the art of snack food manufacture.

In accordance with the preferred embodiments of the present invention, the sodium chloride content of an expanded snack food produced from a starch-based snack food pellet can be reduced. An initial composition for forming a starch-based snack food pellet comprises a starch matrix and sodium chloride, the starch matrix including a crystalline fraction and an amorphous fraction. The sodium chloride content of the composition is reduced and the weight ratio between the crystalline fraction and the amorphous fraction is reduced to form a reduced sodium chloride composition. In some embodiments, the weight ratio of the crystalline fraction to the amorphous fraction is reduced to a value within a range of from 0.52 to 0.60, for example from 0.54 to 0.58.

The combination of these steps can provide that a temperature difference between a relatively low temperature peak associated with amylose in the starch and a relatively high temperature peak associated with amylopectin in the starch, when subjected to differential scanning calorimetry, has substantially the same value for the initial composition and the reduced sodium chloride composition. As described above, the temperature difference is typically from 10 to 32° C., optionally from 17 to 30° C. The combination of these steps can also provide that a temperature peak associated with amylopectin in the starch, when subjected to differential scanning calorimetry, has substantially the same value for the initial composition and the reduced sodium chloride composition. As described above, the temperature peak associated with amylopectin in the starch is typically within the range of from 71 to 103° C., optionally from 80 to 88° C., for the initial composition and the reduced sodium chloride composition.

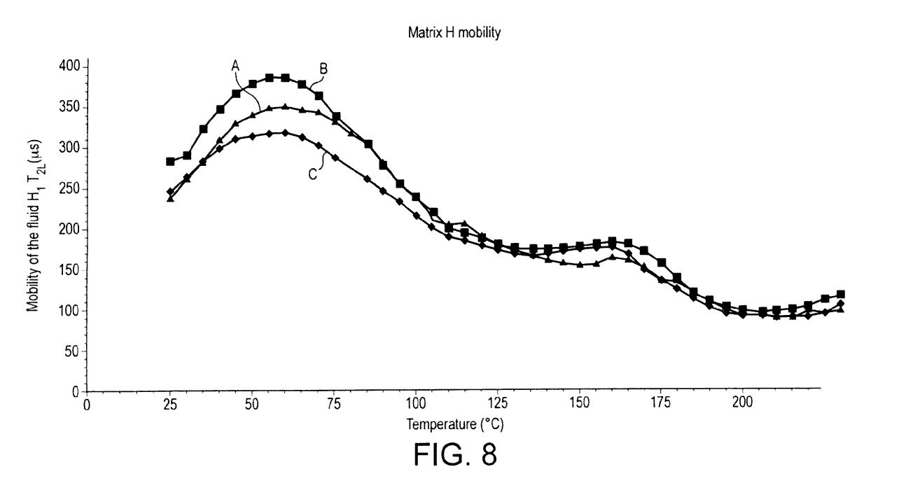

FIG. 8 is a graph showing the relationship between the matrix hydrogen mobility and temperature for three starch-based compositions as measured by hydrogen nuclear magnetic resonance (NMR) throughout exposure to an environment of increasing temperature.

One starch-based composition, indicated as composition A, in accordance with an embodiment of the present invention and free of sodium chloride, comprised a blend of 90 wt % of a conventional commercial potato starch having a high degree of crystallinity and 10 wt % of a highly amorphous potato starch product, in particular a refined potato starch available in commerce under the trade name N-Hance 69 from Ingredion UK Limited, Manchester, United Kingdom. The second and third starch-based compositions, indicated as composition B and composition C comprised 100 wt % of the same conventional commercial potato starch as in composition A, with composition B additionally comprising 0.45 wt % sodium chloride and composition C being free of sodium chloride.

It may be seen that the mobility of the matrix hydrogen for the sodium-free composition C was low, particularly at a temperature of about 75° C. which is a typical expansion temperature when forming an expanded snack food from a pellet. In contrast, the mobility of the matrix hydrogen for the restructured starch composition A and for the sodium chloride-containing composition B was high, particularly at the temperature of about 75° C. This graph shows that the matrix hydrogen mobility was increased by restructuring the crystalline starch matrix with additional amorphous starch, or by adding sodium chloride to the crystalline starch matrix. An increase in matrix hydrogen mobility corresponds to an increase in homogeneity of fluidity of the starch matrix when subjected to expansion when forming the expanded snack food piece from a starch-based pellet.

Various modifications to the present invention will be readily apparent to those skilled in the art.

1. A starch-based snack food pellet for manufacturing an expanded snack food, the pellet being essentially free of sodium chloride and comprising a starch matrix, the starch matrix including a crystalline fraction and an amorphous fraction, wherein the weight ratio of the crystalline fraction to the amorphous fraction is from 0.52 to 0.60.

2. A starch-based snack food pellet according to claim 1 wherein the weight ratio of the crystalline fraction to the amorphous fraction is from 0.54 to 0.58.

3. A starch-based snack food pellet according to claim 1 wherein the starch matrix includes potato starch.

4. A starch-based snack food pellet according to claim 1 wherein the starch matrix comprises a first crystalline starch composition and a second amorphous starch composition.

5. A starch-based snack food pellet according to claim 4 wherein the first and second starch compositions have been blended together to form the starch matrix.

6. A starch-based snack food pellet according to claim 4 wherein the first starch composition comprises a majority of crystalline starch and a minority of amorphous starch, and the second starch composition comprises a majority of amorphous starch and a minority of crystalline starch.

7. A starch-based snack food pellet according to claim 6 wherein the first starch composition comprises at least 25 wt % crystalline starch based on the weight of the first starch composition, and the second starch composition comprises at least 80 wt % amorphous starch based on the weight of the second starch composition.

8. A starch-based snack food pellet according to claim 4 wherein the starch matrix includes from 75 to 95 wt %, optionally from 80 to 90 wt %, of the first starch composition and from 5 to 25 wt %, optionally from 10 to 20 wt %, of the second starch composition, each based on the weight of the starch matrix.

9. A starch-based snack food pellet according to claim 1 wherein the pellet comprises from 70 to 99 wt % starch, optionally from 80 to 99 wt % starch, based on the total weight of the pellet.

10. A starch-based snack food pellet according to claim 1 wherein the pellet comprises no more than 0.2 wt % sodium chloride, optionally no more than 0.1 wt % sodium chloride, based on the total weight of the pellet.

11. A starch-based snack food pellet according to claim 1 wherein the pellet comprises no more than 15 wt % water, optionally from 8 to 14 wt % water, based on the total weight of the pellet.

12. A starch-based snack food pellet according to claim 1 wherein the pellet further comprises at least one fibrous vegetable-derived ingredient.

13. A starch-based snack food pellet according to claim 12 wherein the at least one fibrous vegetable-derived ingredient comprises a potato ingredient.

14. A starch-based snack food pellet according to claim 1 wherein the pellet further comprises at least one fibrous cereal-derived ingredient.

15. A starch-based snack food pellet according to claim 14 wherein the at least one fibrous cereal-derived ingredient comprises at least one of a maize, wheat, oat, rice or barley ingredient.

16. A starch-based snack food pellet according to claim 1 wherein the starch matrix when subjected to differential scanning calorimetry has a temperature difference between a relatively low temperature peak associated with amylose in the starch and a relatively high temperature peak associated with amylopectin in the starch, the temperature difference being from 10 to 32° C.

17. A starch-based snack food pellet according to claim 1 wherein the starch matrix when subjected to differential scanning calorimetry has a temperature peak associated with amylopectin in the starch, the temperature peak being within the range of from 71 to 103° C.

18. A starch-based snack food pellet for manufacturing an expanded snack food, the pellet comprising from greater than 1 to up to 8 wt % sodium chloride, based on the total weight of the pellet, and comprising a starch matrix, the starch matrix including a crystalline fraction and an amorphous fraction, wherein the weight ratio of the crystalline fraction to the amorphous fraction is from 0.52 to 0.60.

19. A starch-based snack food pellet according to claim 18 wherein the weight ratio of the crystalline fraction to the amorphous fraction is from 0.54 to 0.58.

20. A starch-based snack food pellet according to claim 18 wherein the starch matrix includes potato starch.

21. A starch-based snack food pellet according to any one of claim 18 wherein the starch matrix comprises a first crystalline starch composition and a second amorphous starch composition.

22. A starch-based snack food pellet according claim 21 wherein the first and second starch compositions have been blended together to form the starch matrix.

23. A starch-based snack food pellet according to claim 21 wherein the first starch composition comprises a majority of crystalline starch and a minority of amorphous starch, and the second starch composition comprises a majority of amorphous starch and a minority of crystalline starch.

24. A starch-based snack food pellet according to claim 23 wherein the first starch composition comprises at least 25 wt % crystalline starch based on the weight of the first starch composition, and the second starch composition comprises at least 80 wt % amorphous starch based on the weight of the second starch composition.

25. A starch-based snack food pellet according to claim 21 wherein the starch matrix includes from 75 to 95 wt %, optionally from 80 to 90 wt %, of the first starch composition and from 5 to 25 wt %, optionally from 10 to 20 wt %, of the second starch composition, each based on the weight of the starch matrix.

26. A starch-based snack food pellet according to claim 18 wherein the pellet comprises from 70 to less than 99 wt % starch, optionally from 80 to less than 99 wt % starch, based on the total weight of the pellet.

27. A starch-based snack food pellet according to claim 18 wherein the pellet comprises from 0.4 to 2 wt % sodium chloride, optionally from 0.5 to 1 wt % sodium chloride, based on the total weight of the pellet.

28. A starch-based snack food pellet according to claim 18 wherein the pellet comprises no more than 15 wt % water, optionally from 8 to 14 wt % water, based on the total weight of the pellet.

29. A starch-based snack food pellet according to claim 18 wherein the pellet further comprises at least one fibrous vegetable-derived ingredient.

30. A starch-based snack food pellet according to claim 29 wherein the at least one fibrous vegetable-derived ingredient comprises a potato ingredient.

31. A starch-based snack food pellet according to claim 18 wherein the pellet further comprises at least one fibrous cereal-derived ingredient.

32. A starch-based snack food pellet according to claim 31 wherein the at least one fibrous cereal-derived ingredient comprises at least one of a maize, wheat, oat, rice or barley ingredient.

33. A starch-based snack food pellet according to claim 18 wherein the starch matrix when subjected to differential scanning calorimetry has a temperature difference between a relatively low temperature peak associated with amylose in the starch and a relatively high temperature peak associated with amylopectin in the starch, the temperature difference being from 10 to 32° C.

34. A starch-based snack food pellet according to claim 18 wherein the starch matrix when subjected to differential scanning calorimetry has a temperature peak associated with amylopectin in the starch, the temperature peak being within the range of from 71 to 103° C.

35. A starch-based snack food pellet for manufacturing an expanded snack food, the pellet comprising a starch matrix, the starch matrix including a crystalline fraction and an amorphous fraction, the pellet having an initial water content of from 8 to 14 wt % based on the weight of the pellet, wherein the pellet starch matrix has a water absorption of from 15 to 25 wt %, based on the weight of the starch matrix when the starch matrix is disposed in an atmosphere having a relative humidity of 90 wt % water vapour at a temperature of 24.9° C.

36. A starch-based snack food pellet according to claim 35 wherein the starch matrix has a water absorption of from 18 to 22 wt %, based on the weight of the starch matrix, when the starch matrix is disposed in an atmosphere having a relative humidity of 90 wt % water vapour at a temperature of 24.9° C.

37. A starch-based snack food pellet according to claim 35 wherein the starch matrix includes potato starch.

38. A starch-based snack food pellet according to claim 35 wherein the starch matrix comprises a first crystalline starch composition and a second amorphous starch composition.

39. A starch-based snack food pellet according claim 38 wherein the first and second starch compositions have been blended together to form the starch matrix.

40. A starch-based snack food pellet according to claim 38 wherein the first starch composition comprises a majority of crystalline starch and a minority of amorphous starch, and the second starch composition comprises a majority of amorphous starch and a minority of crystalline starch.

41. A starch-based snack food pellet according to claim 40 wherein the first starch composition comprises at least 25 wt % crystalline starch based on the weight of the first starch composition, and the second starch composition comprises at least 80 wt % amorphous starch based on the weight of the second starch composition.

42. A starch-based snack food pellet according to claim 38 wherein the starch matrix includes from 75 to 95 wt %, optionally from 80 to 90 wt %, of the first starch composition and from 5 to 25 wt %, optionally from 10 to 20 wt %, of the second starch composition, each based on the weight of the starch matrix.

43. A starch-based snack food pellet according to claim 35 wherein the pellet comprises from 70 to 99 wt % starch, optionally from 80 to 99 wt % starch, based on the total weight of the pellet.

44. A starch-based snack food pellet according to claim 35 wherein the pellet further comprises no more than 0.2 wt % sodium chloride, optionally no more than 0.1 wt % sodium chloride, based on the total weight of the pellet.

45. A starch-based snack food pellet according to claim 35 wherein the pellet further comprises from 0.4 to 2 wt % sodium chloride, optionally from 0.5 to 1 wt % sodium chloride, based on the total weight of the pellet.

46. A starch-based snack food pellet according to claim 35 wherein the pellet comprises no more than 15 wt % water, optionally from 8 to 14 wt % water, based on the total weight of the pellet.

47. A starch-based snack food pellet according to claim 35 wherein the pellet further comprises at least one fibrous vegetable-derived ingredient.

48. A starch-based snack food pellet according to claim 47 wherein the at least one fibrous vegetable-derived ingredient comprises a potato ingredient.

49. A starch-based snack food pellet according to claim 35 wherein the pellet further comprises at least one fibrous cereal-derived ingredient.

50. A starch-based snack food pellet according to claim 49 wherein the at least one fibrous cereal-derived ingredient comprises at least one of a maize, wheat, oat, rice or barley ingredient.

51. A starch-based snack food pellet for manufacturing an expanded snack food, the pellet comprising a blend of a first starch component in which a majority of the starch is present in a crystalline form and a second starch component in which a majority of the starch is present in an amorphous form, the weight of the first starch component in the blend being greater than the weight of the second starch component in the blend, wherein a first temperature peak, as measured by differential scanning calorimetry, associated with amylopectin in the blend of the first and second starch components is at substantially the same temperature as a second temperature peak, as measured by differential scanning calorimetry, associated with amylopectin of a reference composition, the reference composition comprising the first starch component in combination with 0.89 wt % sodium chloride based on the weight of the reference composition.

52. A starch-based snack food pellet according to claim 51 wherein the first temperature peak is within +/−5° C. of the second temperature, optionally within +/−2° C. of the second temperature.

53. A starch-based snack food pellet according to claim 51 wherein the first temperature peak is within the range of from 71 to 103° C., optionally from 80 to 88° C.

54. A starch-based snack food pellet according to claim 51 wherein the pellet comprises from 0.4 to 2 wt % sodium chloride, optionally from 0.5 to 1 wt % sodium chloride, based on the total weight of the pellet.

55. A starch-based snack food pellet according to claim 51 wherein the pellet is essentially free of sodium chloride, optionally comprises no more than 0.2 wt % sodium chloride, further optionally no more than 0.1 wt % sodium chloride, based on the total weight of the pellet.

56. An expanded snack food produced from the starch-based snack food pellet according to claim 51.

57. An expanded snack food according to claim 56 which is fried, baked, microwaved, directly extruded or popped.

58. A method of reducing the sodium chloride content of an expanded snack produced food from a starch-based snack food pellet, the method comprising the steps of:
a. providing an initial composition for forming a starch-based snack food pellet, the composition comprising a starch matrix and sodium chloride, the starch matrix including a crystalline fraction and an amorphous fraction;
b. reducing the sodium chloride content of the composition; and
c. reducing the weight ratio between the crystalline fraction and the amorphous fraction to form a reduced sodium chloride composition.

59. A method according to claim 58 wherein the weight ratio of the crystalline fraction to the amorphous fraction is reduced to a value within a range of from 0.52 to 0.60.

60. A method according to claim 59 wherein the weight ratio of the crystalline fraction to the amorphous fraction is reduced to a value within a range of from 0.54 to 0.58.

61. A method according to claim 58 wherein the combination of steps b and c provides that a temperature difference between a relatively low temperature peak associated with amylose in the starch and a relatively high temperature peak associated with amylopectin in the starch, when subjected to differential scanning calorimetry, has substantially the same value for the initial composition and the reduced sodium chloride composition.

62. A method according to claim 61 wherein the temperature difference is from 10 to 32° C.

63. A method according to claim 58 wherein the combination of steps b and c provides that a temperature peak associated with amylopectin in the starch, when subjected to differential scanning calorimetry, has substantially the same value for the initial composition and the reduced sodium chloride composition.

64. A method according to claim 63 wherein the temperature peak associated with amylopectin in the starch is within the range of from 71 to 103° C. for the initial composition and the reduced sodium chloride composition.
